(19) United States
(12) Patent Application Publication
(10) Pub. No.: US 2020/0205148 A1
(43) Pub. Date: Jun. 25, 2020

(54) USER TERMINAL AND RADIO COMMUNICATION METHOD

(71) Applicant: NTT DOCOMO, INC., Tokyo (JP)

(72) Inventors: Shohei Yoshioka, Tokyo (JP); Kazuki Takeda, Tokyo (JP); Satoshi Nagata, Tokyo (JP)

(73) Assignee: NTT DOCOMO, INC., Tokyo (JP)

(21) Appl. No.: 16/644,426

(22) PCT Filed: Sep. 8, 2017
(86) PCT No.: PCT/JP2017/032588

§ 371 Date: Mar. 4, 2020

(51) Int. Cl. H04W 72/04; H04L 5/00; H04W 72/12; H04L 27/26

(52) U.S. Cl. CPC H04W 72/0413; H04L 5/0053; H04W 72/0446; H04W 72/12; H04L 27/262; H04L 5/0048

(57) ABSTRACT

A user terminal includes: a transmission section that transmits uplink data and uplink control information by using an uplink shared channel; and a control section that controls multiplexing of the uplink control information such that a number of pieces of the uplink control information to be multiplexed per given block of the uplink data is distributed and/or becomes a given value or less.

### TECHNICAL FIELD

The present invention relates to a user terminal and a radio communication method of a next-generation mobile communication system.

### BACKGROUND ART

In Universal Mobile Telecommunications System (UMTS) networks, for the purpose of higher data rates and lower latency, Long Term Evolution (LTE) has been specified (Non-Patent Literature 1). Furthermore, for the purpose of wider bands and a higher speed than those of LTE, LTE successor systems (also referred to as, for example, LTE Advanced (LTE-A), Future Radio Access (FRA), 5G; 5G+ (plus), New-RAT (NR), and LTE Rel. 14 and 15˜) have been also studied. Uplink (UL) of legacy LTE systems (e.g., LTE Rel. 8 to 13) supports a DFT-spread-OFDM (DFT-s-OFDM: Discrete Fourier Transform-Spread-Orthogonal Frequency Division Multiplexing) waveform. The DFT-spread-OFDM waveform is a single carrier waveform, and consequently can prevent an increase in a Peak to Average Power Ratio (PAPR).

Furthermore, in the legacy LTE systems (e.g., LTE Rel. 8 to 13), the user terminal transmits Uplink Control Information (UCI) by using a UL data channel (e.g., PUSCH: Physical Uplink Shared Channel) and/or a UL control channel (e.g., PUCCH: Physical Uplink Control Channel).

Transmission of the UCI is controlled based on whether or not simultaneous PUSCH and PUCCH transmission is configured, and whether or not the PUSCH is scheduled in a TTI for transmitting the UCI. Transmitting UCI by using a PUSCH will be also referred to as UCI on PUSCH.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8)”, April 2010

### SUMMARY OF INVENTION

### Technical Problem

When transmission of uplink data (e.g., UL-SCH) and a transmission timing of Uplink Control Information (UCI) overlap, the legacy LTE systems transmit the uplink data and the UCI by using an uplink shared channel (PUSCH) (UCI on PUSCH). It is considered that a future radio communication system also transmits uplink data and UCI (e.g., A/N) by using a PUSCH similar to the legacy LTE systems.

Furthermore, it has been agreed for the future radio communication system that a demodulation reference signal is arranged at a position different from those of the legacy LTE systems during UL transmission. Thus, a problem is how to control transmission of uplink control information that uses an uplink shared channel when a configuration different from those of the legacy LTE systems is applied.

The present invention has been made in light of this point, and one of objects of the present invention is to provide a user terminal and a radio communication method that can appropriately perform communication even when uplink data and uplink control information are transmitted by using an uplink shared channel in a future radio communication system.

### Solution to Problem

One aspect of a user terminal according to the present invention includes: a transmission section that transmits uplink data and uplink control information by using an uplink shared channel; and a control section that controls multiplexing of the uplink control information such that a number of pieces of the uplink control information to be multiplexed per given block of the uplink data is distributed and/or becomes a given value or less.

### Advantageous Effects of Invention

According to the present invention, it is possible to appropriately perform communication even when uplink data and uplink control information are transmitted by using an uplink shared channel in a future radio communication system.

### BRIEF DESCRIPTION OF DRAWINGS

FIG. 1A illustrates one example of a DMRS arrangement for a PUSCH in a legacy LTE system, and FIG. 1B is a diagram illustrating one example of a DMRS arrangement in a future radio communication system.

FIG. 2 is a diagram for explaining a case where rate matching processing and puncture processing are applied as a UCI mapping method.

FIGS. 3A and 3B are diagrams illustrating one example of UCI multiplexing positions (positions to be punctured) when frequency-first mapping is applied to UL data.

FIGS. 4A and 4B are diagrams illustrating one example of UCI multiplexing positions (positions to be punctured) when time-first mapping is applied to UL data.

FIGS. 5A and 5B are diagrams illustrating one example of a case where UCI (resources to be punctured) is distributed between CBs when frequency-first mapping is applied.

FIGS. 6A and 6B are diagrams illustrating one example of a case where UCI (resources to be punctured) is distributed between CBs when time-first mapping is applied.

FIGS. 7A and 7B are diagrams illustrating one example of a case where interleaving is applied to UCI when frequency-first mapping is applied.

FIGS. 8A and 8B are diagrams illustrating one example of a case where interleaving is applied to UCI when time-first mapping is applied.

FIGS. 9A and 9B are diagrams illustrating one example of a case where a maximum value of the number of times of UCI multiplexing (the number of times of puncturing) is configured to a CB to control UCI multiplexing.

FIG. 10 is a diagram illustrating one example of a schematic configuration of a radio communication system according to the present embodiment.

FIG. 11 is a diagram illustrating one example of an overall configuration of a radio base station according to the present embodiment.

FIG. 12 is a diagram illustrating one example of a function configuration of the radio base station according to the present embodiment.

FIG. 13 is a diagram illustrating one example of an overall configuration of a user terminal according to the present embodiment.

FIG. 14 is a diagram illustrating one example of a function configuration of the user terminal according to the present embodiment.

FIG. 15 is a diagram illustrating one example of hardware configurations of the radio base station and the user terminal according to the present embodiment.

### DESCRIPTION OF EMBODIMENTS

UL transmission of legacy LTE systems supports a method (also referred to as UCI piggyback on PUSCH or UCI on PUSCH) for multiplexing UCI and UL data on a PUSCH to transmit when UCI transmission and UL data (UL-SCH) transmission occur at the same timing. By using UCI on PUSCH, it is possible to achieve a low Peak-to-Average Power Ratio (PAPR) and/or low Inter-Modulation Distortion (1 MB) during UL transmission.

It has been studied for UL transmission of a future radio communication system (e.g., LTE Rel. 14 or subsequent releases, 5G or NR), too, to support UCI on PUSCH.

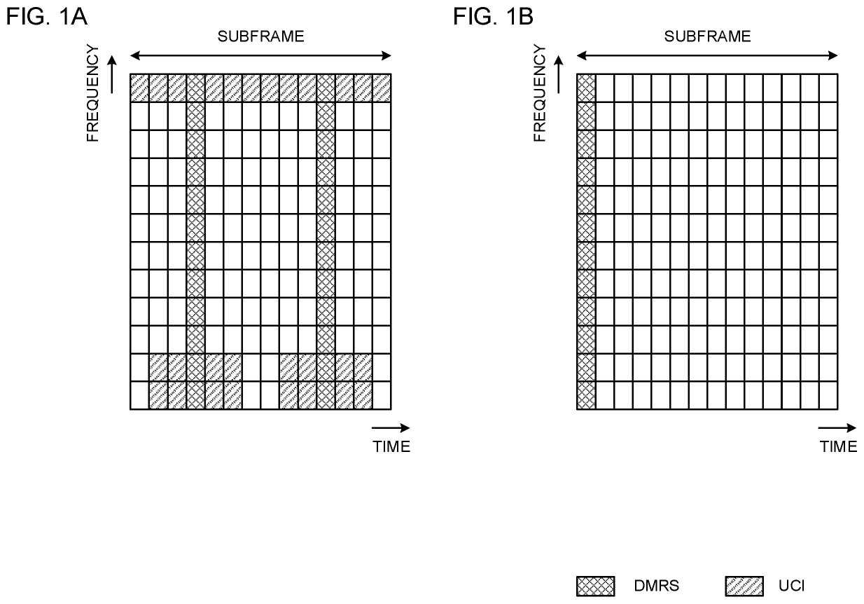

Furthermore, the legacy LTE systems arrange Demodulation Reference Signals (also referred to as DMRSs) for a PUSCH on 2 symbols (e.g., a 4th symbol and an 11th symbol) of a subframe (see FIG. 1A). On the other hand, it has been agreed for the future radio communication system to arrange the DMRS for the PUSCH at a head of a subframe (or a slot) during UL transmission (see FIG. 1B). Thus, the future radio communication system employs a PUSCH configuration different from those of the legacy LTE systems, and therefore it is desired to apply UCI on PUSCH suitable to the PUSCH configuration.

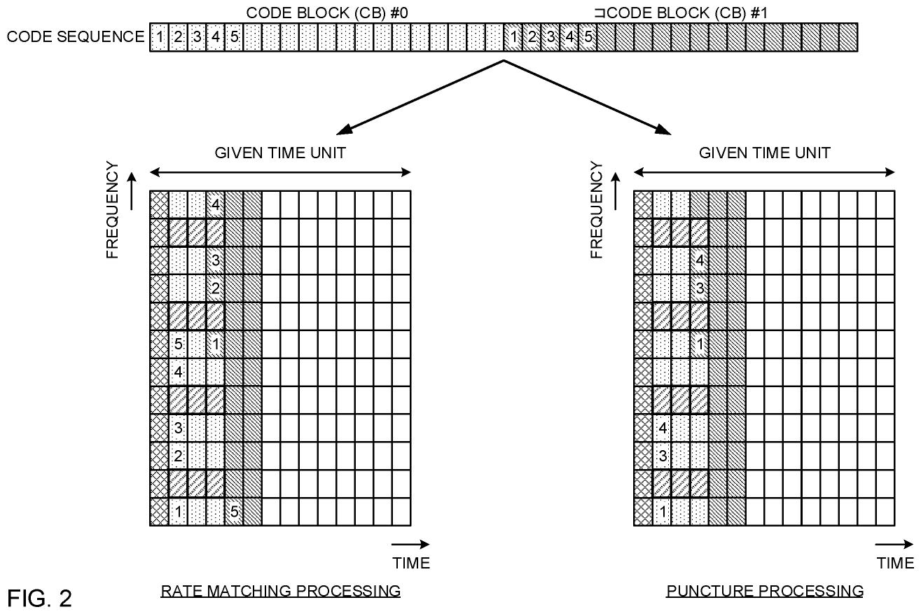

As a method for multiplexing Uplink Control Information (UCI) on a PUSCH, it is considered to apply rate matching processing and/or puncture processing. FIG. 2 illustrates a case where rate matching processing or puncture processing is applied to uplink data to be transmitted by a plurality of code blocks (a CB #0 and a CB #1 in this case) to multiplex UCI.

FIG. 2 illustrates a UCI multiplexing method in a case where uplink data is transmitted on the PUSCH in a Code Block (CB) unit. The CB is a unit that is configured by segmenting a Transport Block (TB).

When a Transport Block Size (TBS) exceeds a given threshold (e.g., 6144 bits), the legacy LTE system segments the TB into one or more segments (Code Blocks (CBs)), and encodes the TB in a segment unit (Code Block Segmentation). Each encoded code block is jointed and transmitted. The TBS is a size of a transport block that is an information bit sequence unit. One or a plurality of TBs are allocated to 1 subframe.

Rate matching processing refers to controlling the number of bits after encoding (encoded bits) by taking actually available radio resources into account. That is, the rate matching processing changes and controls a code rate of UL data according to the number of pieces of UCI to be multiplexed (see FIG. 2). More specifically, as illustrated in FIG. 2, each CB sequence (1 to 5) is controlled so as not to be allocated to a UCI multiplexing position. Thus, although it is possible to multiplex the UCI without destroying the code sequences of UL data, if UCI multiplexing cannot be shared between a base station and a UE, it is not possible to correctly obtain data.

Furthermore, puncture processing refers to performing encoding assuming that resources allocated to data can be used while not mapping encoded symbols on resources (e.g., UCI resources) that cannot be actually used (i.e., keeping resources). That is, UCI is overwritten on the code sequences of the mapped UL data (see FIG. 2). More specifically, irrespectively of the UCI multiplexing positions illustrated in FIG. 2, the CB sequences (1 to 5) are allocated, and sequences (2 and 5) on which UCI is multiplexed are overwritten with the UCI. Consequently, positions of other code sequences are not collapsed, and therefore even if there is a variation of UCI multiplexing between the base station and the UE, it is possible to easily obtain data correctly.

The future radio communication system is assumed to apply at least puncture processing to UCI on PUSCH. However, there is a problem that, when puncture processing is applied, as the number of symbols to be punctured increases, an error rate of uplink data deteriorates.

It has been studied for the future radio communication system to perform retransmission control in a unit of a TB or a group (CBG: Code Block Group) including or one or more CBs. Hence, the base station performs error detection on UL data transmitted from the UE per CB, and transmits ACK/NACK for all CBs (TBs) or per CBG (a plurality of CBs). Therefore, when an error rate of a specific CB deteriorates, there is a risk that CBs that can be appropriately received by the base station are also retransmitted, and problems such as an increase in an overhead and/or delay occur.

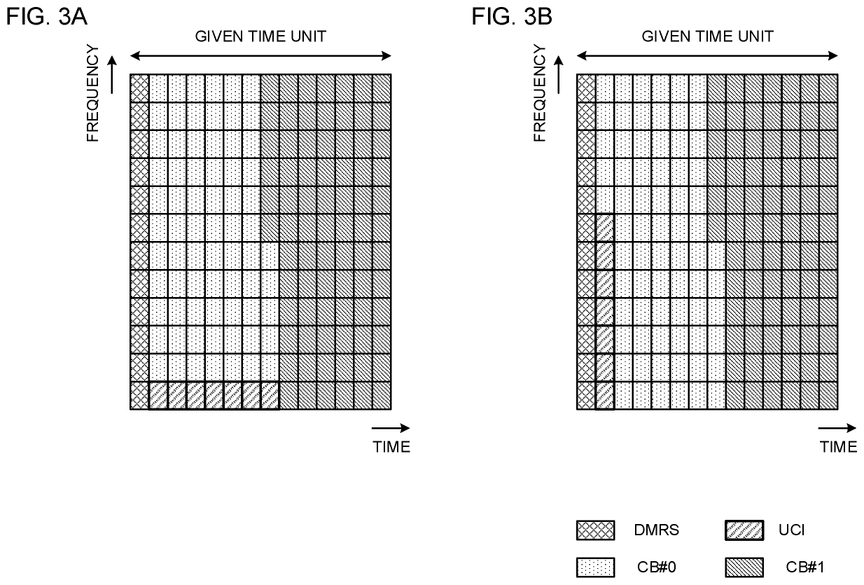

When UCI is multiplexed in a contiguous time direction as illustrated in, for example, FIG. 3A, the number of times of puncturing of a specific CB (the CB #1 in this case) becomes large, and the number of times of puncturing varies between a plurality of CBs. Furthermore, when UCI is multiplexed in a contiguous frequency direction as illustrated in FIG. 3B, the number of times of puncturing of a specific CB (the CB #1 in this case) becomes large. In addition, FIG. 3 illustrates a case where UL data (CBs) is mapped first in the frequency direction, and then is mapped in the time direction (frequency-first mapping is applied).

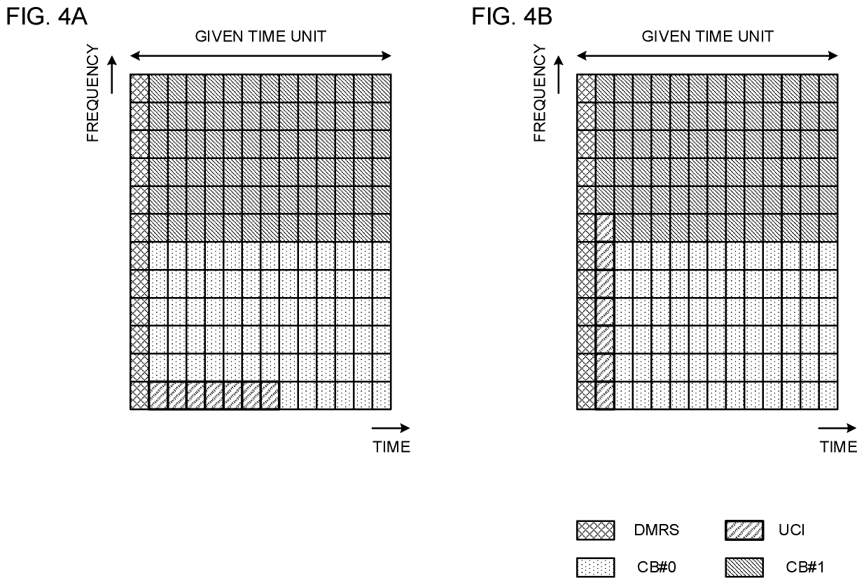

Furthermore, there is also considered likewise a case where UL data is mapped first in the time direction, and then is mapped in the frequency direction (time-first mapping is applied) (see FIG. 4). FIG. 4A illustrates a case where UCI is multiplexed in the contiguous time direction (FIG. 4A), and FIG. 4B illustrates a case where UCI is multiplexed in the frequency direction (FIG. 4B). In FIGS. 4A and 4B, the number of times of puncturing of the specific CB (the CB #1 in this case) is large, and the number of times of puncturing varies between a plurality of CBs.

In the cases illustrated in FIGS. 3 and 4, the error rate of the CB #1 whose number of resources to be punctured is large compared to a CB #2, and a probability that the base station side makes a reception mistake of the CB #1 becomes high. When the CB #1 and the CB #2 are included in the same TB or CBG and the base station makes the reception mistake of only the CB #1, there is a risk that the CB #2 also needs to be retransmitted, and an increase in an overhead and delay occur, and thereby deteriorate communication quality.

The inventors of this application have focused on that it is possible to reduce a difference in the error rate of each CB by reducing a difference in the number of resources (e.g., the number of symbols and/or the number of resource elements) to be punctured per CB, and conceived controlling UCI multiplexing such that the number of pieces of UCI to be respectively multiplexed per CB and/or the number of resources to be punctured are distributed.

Furthermore, the inventors of this application have conceived controlling positions of UCI to be multiplexed on each CB to a proximity of demodulation reference signals of uplink data when the UCI is multiplexed over a plurality of CBs. When, for example, a DMRS is arranged at a head of a given time unit (a subframe, a slot or a mini slot), UCI is controlled to be multiplexed on the earliest symbol in at least the time direction in each CB.

The present embodiment will be described in detail below. Furthermore, according to the present embodiment, the UCI includes at least one of a Scheduling Request (SR), transmission acknowledgement information (also referred to as, for example, HARQ-ACK: Hybrid Automatic Repeat reQuest-Acknowledge, ACK or Negative ACK (NACK) or A/N) for a DL data channel (e.g., PDSCH: Physical Downlink Shared Channel), Channel State Information (CSI), beam index information (BI: Beam Index), and a Buffer Status Report (BSR).

In addition, the following description will describe a case where two or three CBs are mapped in a given time unit. However, the number of CBs to be mapped in the given time unit may be four or more. Furthermore, the present embodiment may be applied to a given block unit other than the CB unit. Furthermore, the following description will describe a case where at least puncture processing is applied as the UCI multiplexing method. However, rate matching processing may be used in combination instead of applying the puncture processing alone.

(First Aspect) According to the first aspect, UCI multiplexing is controlled such that the number of resources (e.g. the number of symbols and/or the number of resource elements) to be punctured in each CB becomes equal (or a difference between the numbers of resources is one).

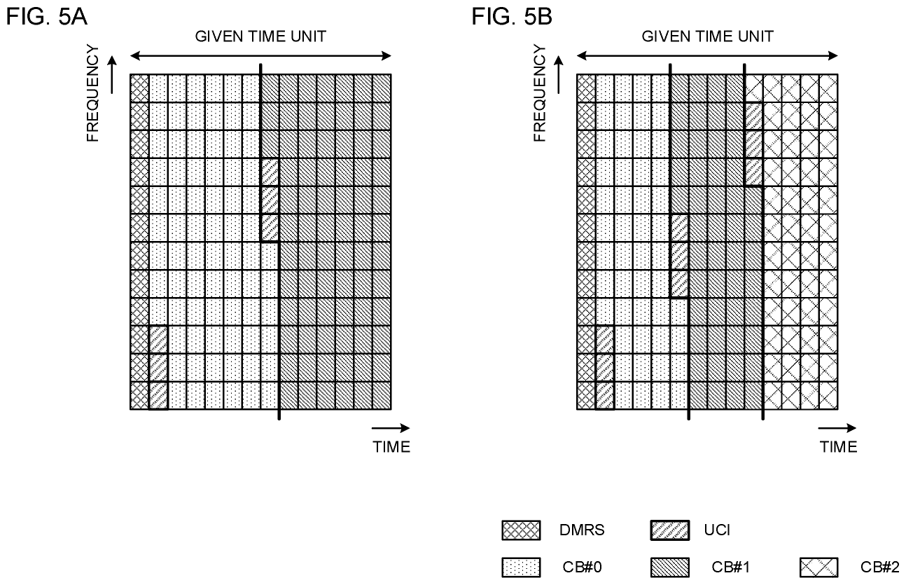

FIG. 5 illustrates a case where UL data and Uplink Control Information (UCI) are multiplexed on an uplink shared channel (PUSCH) in a given time unit. FIG. 5 illustrates a configuration where a PUSCH demodulation reference signal (DMRS) is arranged in a head domain (e.g., a head symbol) of the given time unit. In this regard, the DMRSs may be arranged in other symbols in addition to the head symbol.

FIG. 5A illustrates a case where two CBs (a CB #0 and a CB #1) are used to transmit UL data, and FIG. 5B illustrates a case where three CBs (the CB #0 to a CB #2) are used to transmit UL data. Furthermore, at least puncture processing is applied as a UCI multiplexing method.

A UE controls UCI multiplexing such that the number of pieces of UCI to be multiplexed (the number of resources to be punctured) is distributed in each CB. For example, the UE controls UCI multiplexing such that the number of pieces of UCI to be multiplexed on each CB is equal (or the difference between the numbers of pieces of UCI is at least one). In this case, the UE may determine the number of resources to be punctured in each CB (the number of pieces of UCI to be multiplexed on each CB) by using following equation (1).

$$\begin{matrix}[ Mathematical 1 ] & \\ {Q}_{r}^{′} = \frac{{Q}^{′}}{C} & ( Equation 1 )\end{matrix}$$

Q′ᵣ: The number of pieces of UCI to be punctured in the CB # r
Q′: The number of pieces of UCI to be punctured
C: The number of CBs

FIG. 5A illustrates a case where, when a total number of pieces of UCI to be punctured is six, the three resources are respectively punctured in each of the CB #0 and the CB #1 to multiplex the UCI. Furthermore, FIG. 5B illustrates a case where, when a total number of pieces of UCI to be punctured is nine, the three resources are respectively punctured in each of the CB #0 to the CB #2 to multiplex the UCI.

Thus, by distributing (preferably, equalizing) the number of resources to be punctured in each CB, it is possible to equalize an error rate of each CB. Consequently, it is possible to reduce a reception mistake of the base station due to deterioration of an error rate of a specific CB, and prevent occurrence of wasteful retransmission control.

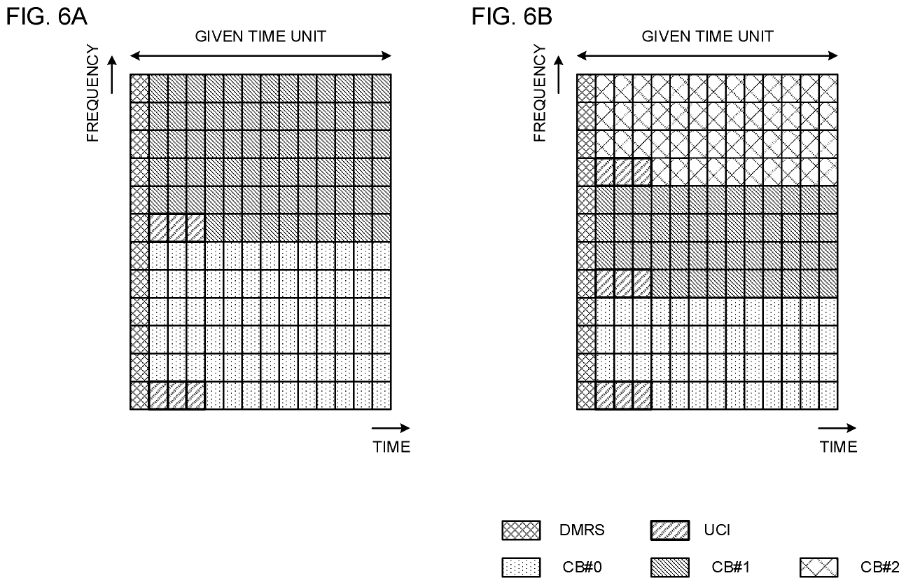

In this regard, FIG. 5 illustrates a case where UL data (or CBs) is mapped first in a frequency direction. However, even when the UL data is mapped first in a time direction, UCI multiplexing (puncture processing) only needs to be controlled to average the number of times of puncturing in each CB (see FIG. 6).

FIG. 6A illustrates a case where two CBs (the CB #0 and the CB #1) are used to apply time-first mapping to UL data, and FIG. 6B illustrates a case where three CBs (the CB #0 to the CB #2) are used to apply time-first mapping to UL data. In this case, too, UCI multiplexing is controlled to distribute the number of pieces of UCI to be multiplexed on each CB.

<UCI Multiplexing Method>

UCI multiplexing positions (puncture positions) with respect to each CB are not limited in particular. The UCI may be arranged in one of a head domain (e.g., a head symbol in the time direction) of each CB, a tail domain (e.g., a last symbol in the time direction), and a center domain. Furthermore, as long as the UCI is distributed in a plurality of CBs, an insertion order of the UCI in each CB is not limited in particular. The UCI may be inserted (or multiplexed) one by one in a plurality of CBs (e.g., the CBs #0 to #2) (e.g., the CBs #0->#1->#2->#0 . . . ), or may be multiplexed on a specific CB, and then multiplexed on a next CB (e.g., the CBs #0->#0->#0->#1 . . . ).

Alternatively, the positions of the UCI to be multiplexed on each CB may be determined by taking DMRSs into account. For example, the positions of the UCI to be multiplexed on each CB may be controlled to be arranged at a proximity of the DMRSs. In one example, when frequency-first mapping is applied (see FIG. 5) and/or when time-first mapping is applied (see FIG. 6), DCI is multiplexed on at least the earliest symbol in the time direction in each CB. Consequently, it is possible to arrange UCI in the proximity (e.g., a neighboring symbol) of the DMRS arranged on the head symbol.

Thus, by arranging the UCI in the proximity of the DMRSs, it is possible to improve channel estimation accuracy of the UCI in the base station. Consequently, it is possible to prevent a detection mistake of the UCI in the base station even when mobility of the UE becomes high.

<Application of Interleaving>

The UE may apply interleave processing according to UCI multiplexing positions. Interleaving refers to processing of rearranging a resource order according to a predetermined pattern. When, for example, UCI is inserted in a tail of each CB (e.g., the latest symbol in the time direction of each CB), interleaving may be applied in a mapping order.

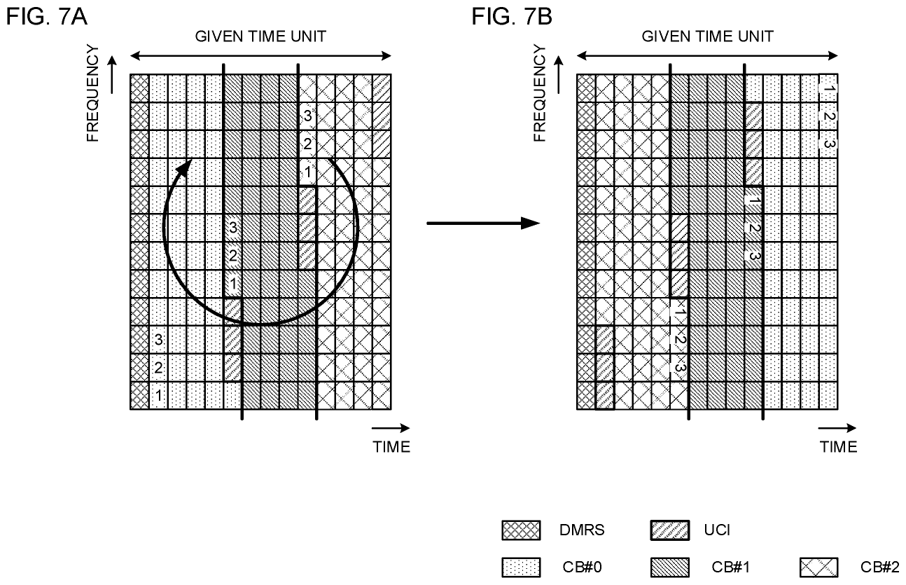

FIG. 7A illustrates a case where, when frequency-first mapping is applied, three pieces of UCI are inserted at a tail of each of the CB #0 to the CB #2. In this case, the UE may apply interleaving in the mapping order. After interleaving, the UCI is arranged at proximity positions of DMRSs in each CB (see FIG. 7B). Consequently, it is possible to improve channel estimation accuracy of each UCI.

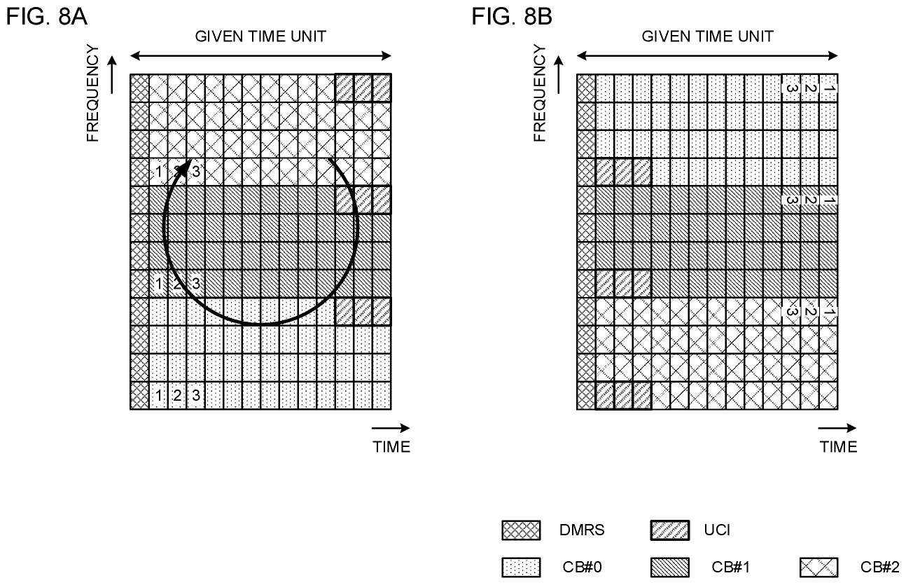

FIG. 8A illustrates a case where, when time-first mapping is applied, three pieces of UCI are inserted at a tail of each of the CB #0 to the CB #2. In this case, the UE may apply interleaving in the mapping order. After interleaving, the UCI is arranged at proximity positions of the DMRSs in each CB (see FIG. 8B). Consequently, it is possible to improve channel estimation accuracy of each UCI.

Interleaving can be controlled in a unit of a CB, a unit of a plurality of CBs or a unit of all CBs. The UE may control application of interleaving according to UCI insertion positions. Furthermore, the UE may apply interleaving even when the UCI insertion positions are not at tails. Interleaving schemes that are applicable to the present embodiment are not limited.

In addition, frequency-first mapping is applied to UL data and UCI in FIGS. 5 and 7.

However, time-first mapping may be applied to the UCI. Furthermore, time-first mapping is applied to UL data and UCI in FIGS. 6 and 8. However, frequency-first mapping may be applied to the UCI.

(Second Aspect) According to the second aspect, a given value is configured to the number of resources (e.g., the number of symbols and/or the number of resource elements) to be punctured in each CB to control multiplexing of UCI on each CB such that the number of resources becomes the given value or less.

The given value (e.g., maximum value) of the number of resources to be punctured in each CB may be a fixed value irrespectively of the number of resources of each CB, or may be a value defined by a ratio (e.g., β % of the number of resources of a CB # r) with respect to the number of resources. For example, the UE may determine a maximum value of the number of resources to be punctured in each CB by using following equation (2).

$$\begin{matrix}[ Mathematical 2 ] & \\ {Q}_{r}^{′} = min ( \frac{{M}_{SC}^{PUSCH} \cdot β}{C} , {Q}^{′} - {\sum }_{{r}^{′}}^{r - 1} {Q}_{{r}^{′}}^{′} ) & ( Equation 2 )\end{matrix}$$

Q′ᵣ: The number of pieces of UCI to be punctured in the CB # r
Q′: The number of pieces of UCI to be punctured
C: The number of CBs
M^{PUSCH}_{SC}: The number of allocation REs
β: The ratio of the number of resources to be punctured in the CB

The UE controls multiplexing of UCI on each CB such that the number of times of puncturing configured to each CB does not exceed the maximum value. In this case, the UE may perform control such that the number of times of UCI multiplexing (the number of resources to be punctured) in each CB is distributed (e.g., CBs #0->#1->#2->#0 . . . ). Furthermore, as described in the above first aspect, the UE may control allocation of UCI such that the number of pieces of UCI (the number of times of puncturing) to be multiplexed on each CB becomes equal. In this case, it is possible to distribute the number of times of puncturing between the respective CBs, and further make the number of times of puncturing of each CB the maximum value or less. Consequently, it is possible to effectively prevent deterioration of an error rate of each CB.

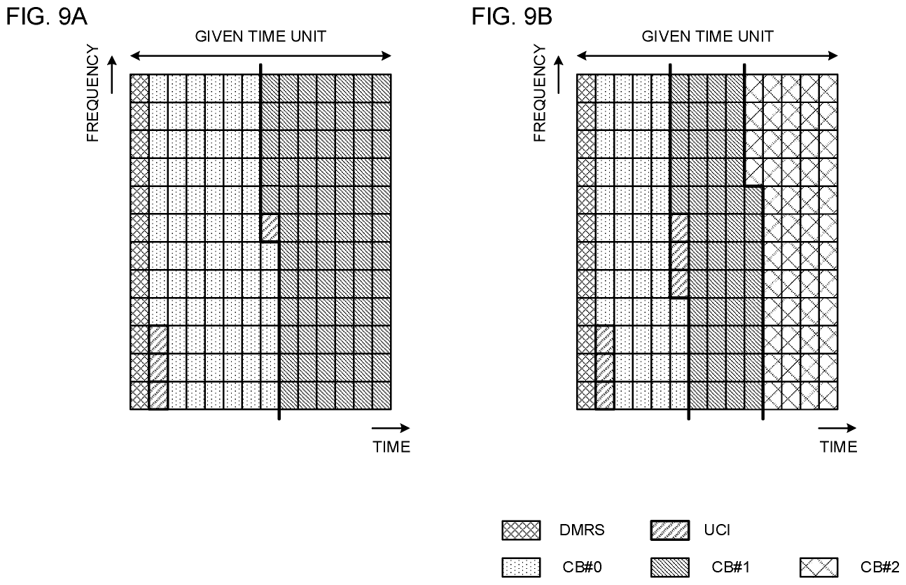

Alternatively, as illustrated in FIG. 9, UCI may be allocated to a specific CB until the number of times of UCI multiplexing reaches the maximum value, and then the rest of pieces of UCI may be allocated to other CBs (CBs #0->#0->#0->#1 . . . ). That is, by configuring the maximum value of the number of pieces of UCI to be multiplexed on a given CB, it is possible to locally multiplex the UCI on the given CB.

FIG. 9A illustrates a case where two CBs (the CB #0 and the CB #1) are used to transmit UL data, and FIG. 9B illustrates a case where three CBs (the CB #0 to the CB #2) are used to transmit UL data. Furthermore, FIGS. 9A and 9B illustrate the cases where the maximum value of the number of pieces of UCI that can be multiplexed on each CB is configured to 3.

FIG. 9A illustrates the case where, when a total number of pieces of UCI to be punctured is four, the UCI is allocated to the CB #0 until the number of times of UCI multiplexing reaches the maximum value (three in this case), and the rest of pieces of (one in this case) UCI is allocated to the CB #1. FIG. 9B illustrates the case where, when a total number of pieces of UCI to be punctured is six, the UCI is allocated in order of the CBs #0 to #2 until the number of times of UCI multiplexing reaches the maximum value (three in this case). This case indicates a configuration where the three pieces of UCI are multiplexed on each of the CBs #0 and #1, and the UCI is not multiplexed on the CB #3. That is, even when the UCI is locally multiplexed on a given CB, the number of times of UCI multiplexing in each CB is a given value (three in this case) or less.

By configuring the maximum value of the number of times of UCI multiplexing in each CB so as not to cause signification deterioration of the error rate of each CB, it is possible to prevent significant deterioration of the error rate of the specific CB even when the number of times of UCI multiplexing (the number of resources to be punctured) differs between the respective CBs as illustrated in FIG. 9. Furthermore, by configuring the maximum value of the number of times of UCI multiplexing in each CB and controlling the UCI multiplexing, it is possible to flexibly control the UCI multiplexing. By, for example, selectively arranging UCI in CBs close to DMRS positions as illustrated in FIG. 9, it is possible to improve channel estimation accuracy of the UCI.

In addition, a UCI multiplexing method and/or interleaving described in the first aspect may be applied likewise to the second aspect.

(Radio Communication System) The configuration of the radio communication system according to the present embodiment will be described below. This radio communication system is applied the radio communication method according to each of the above aspects. In addition, the radio communication method according to each of the above aspects may be each applied alone or may be applied in combination.

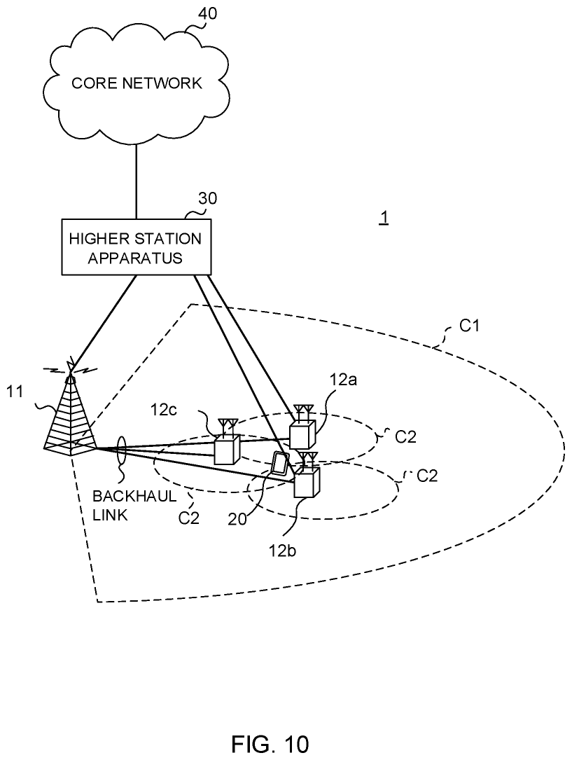

FIG. 10 is a diagram illustrating one example of a schematic configuration of the radio communication system according to the present embodiment. A radio communication system 1 can apply Carrier Aggregation (CA) and/or Dual Connectivity (DC) that aggregate a plurality of base frequency blocks (component carriers) whose 1 unit is a system bandwidth (e.g., 20 MHz) of the LTE system. In this regard, the radio communication system 1 may be referred to as SUPER 3G LTE-Advanced (LTE-A), IMT-Advanced, 5G Future Radio Access (FRA) or New-RAT (NR).

The radio communication system 1 illustrated in FIG. 10 includes a radio base station 11 that forms a macro cell C1, and radio base stations 12a to 12c that are located in the macro cell C1 and form small cells C2 narrower than the macro cell C1. Furthermore, a user terminal 20 is located in the macro cell C1 and each small cell C2. Different numerologies may be configured to be applied between cells. In this regard, the numerology refers to a communication parameter set that characterizes a signal design of a certain RAT and/or an RAT design.

The user terminal 20 can connect with both of the radio base station 11 and the radio base stations 12. The user terminal 20 is assumed to concurrently use the macro cell C1 and the small cells C2 that use different frequencies by CA or DC. Furthermore, the user terminal 20 can apply CA or DC by using a plurality of cells (CCs) (e.g., two or more CCs). Furthermore, the user terminal can use licensed band CCs and unlicensed band CCs as a plurality of cells.

Furthermore, the user terminal 20 can communicate by using Time Division Duplex (TDD) or Frequency Division Duplex (FDD) in each cell. A TDD cell and an FDD cell may be each referred to as a TDD carrier (frame configuration type 2) and an FDD carrier (frame configuration type 1).

Furthermore, in each cell (carrier), one of a subframe (also referred to as, for example, a TTI, a general TTI, a long TTI, a general subframe, a long subframe or a slot) having a relatively long time duration (e.g., 1 ms) or a subframe (also referred to as, for example, a short TTI, a short subframe or a slot) having a relatively short time duration may be applied, or both of the long subframe and the short subframe may be applied. Furthermore, in each cell, a subframe of 2 or more time durations may be applied.

The user terminal 20 and the radio base station 11 can communicate by using a carrier (referred to as a Legacy carrier) of a narrow bandwidth in a relatively low frequency band (e.g., 2 GHz). On the other hand, the user terminal 20 and each radio base station 12 may use a carrier of a wide bandwidth in a relatively high frequency band (e.g., 3.5 GHz, 5 GHz or 30 to 70 GHz) or may use the same carrier as that used between the user terminal 20 and the radio base station 11. In this regard, a configuration of the frequency band used by each radio base station is not limited to this.

The radio base station 11 and each radio base station 12 (or the two radio base stations 12) can be configured to be connected by way of wired connection (e.g., optical fibers compliant with a Common Public Radio Interface (CPRI) or an X2 interface) or radio connection.

The radio base station 11 and each radio base station 12 are each connected with a higher station apparatus 30 and connected with a core network 40 via the higher station apparatus 30. In this regard, the higher station apparatus 30 includes, for example, an access gateway apparatus, a Radio Network Controller (RNC) and a Mobility Management Entity (MME), yet is not limited to these. Furthermore, each radio base station 12 may be connected with the higher station apparatus 30 via the radio base station 11.

In this regard, the radio base station 11 is a radio base station that has a relatively wide coverage, and may be referred to as a macro base station, an aggregate node, an eNodeB (eNB) or a transmission/reception point. Furthermore, each radio base station 12 is a radio base station that has a local coverage, and may be referred to as a small base station, a micro base station, a pico base station, a femto base station, a Home eNodeB (HeNB), a Remote Radio Head (RRH) or a transmission/reception point. The radio base stations 11 and 12 will be collectively referred to as a radio base station 10 below when not distinguished.

Each user terminal 20 is a terminal that supports various communication schemes such as LTE and LTE-A, and may include not only a mobile communication terminal but also a fixed communication terminal. Furthermore, the user terminal 20 can perform Device-to-Device communication (D2D) with the other user terminal 20.

The radio communication system 1 can apply Orthogonal Frequency-Division Multiple Access (OFDMA) to downlink (DL) and can apply Single Carrier-Frequency Division Multiple Access (SC-FDMA) to uplink (UL) as radio access schemes. OFDMA is a multicarrier transmission scheme that divides a frequency band into a plurality of narrow frequency bands (subcarriers) and maps data on each subcarrier to perform communication. SC-FDMA is a single carrier transmission scheme that divides a system bandwidth into bands including one or contiguous resource blocks per terminal and causes a plurality of terminals to use respectively different bands to reduce an inter-terminal interference. In this regard, uplink and downlink radio access schemes are not limited to a combination of these, and OFDMA may be used on UL. Furthermore, SC-FDMA is applicable to Sidelink (SL) used for device-to-device communication.

The radio communication system 1 uses a DL data channel (also referred to as, for example, a PDSCH: Physical Downlink Shared Channel or a DL shared channel) shared by each user terminal 20, a broadcast channel (PBCH: Physical Broadcast Channel) and an L1/L2 control channel as DL channels. At least one of user data, higher layer control information and System Information Blocks (SIBs) is conveyed on the PDSCH. Furthermore, Master Information Blocks (MIBs) are conveyed on the PBCH.

The L1/L2 control channel includes a DL control channel (e.g., a Physical Downlink Control Channel (PDCCH) and/or an Enhanced Physical Downlink Control Channel (EPDCCH)), a Physical Control Format Indicator Channel (PCFICH), and a Physical Hybrid-ARQ Indicator Channel (PHICH). Downlink Control Information (DCI) including scheduling information of the PDSCH and the PUSCH is conveyed on the PDCCH and/or the EPDCCH. The number of OFDM symbols used for the PDCCH is conveyed on the PCFICH. The EPDCCH is subjected to frequency division multiplexing with the PDSCH and is used to convey DCI similar to the PDCCH. Transmission acknowledgement information (A/N or HARQ-ACK) of the PUSCH can be conveyed on at least one of the PHICH, the PDCCH and the EPDCCH.

The radio communication system 1 uses a UL data channel (also referred to as, for example, a PUSCH: Physical Uplink Shared Channel or a UL shared channel) shared by each user terminal 20, a UL control channel (PUCCH: Physical Uplink Control Channel), and a random access channel (PRACH: Physical Random Access Channel) as UL channels. User data and higher layer control information are conveyed on the PUSCH. Uplink Control Information (UCI) including at least one of transmission acknowledgement information (A/N or HARQ-ACK) and Channel State Information (CSI) of the PDSCH is conveyed on the PUSCH or the PUCCH. A random access preamble for establishing connection with a cell can be conveyed on the PRACH.

<Radio Base Station>

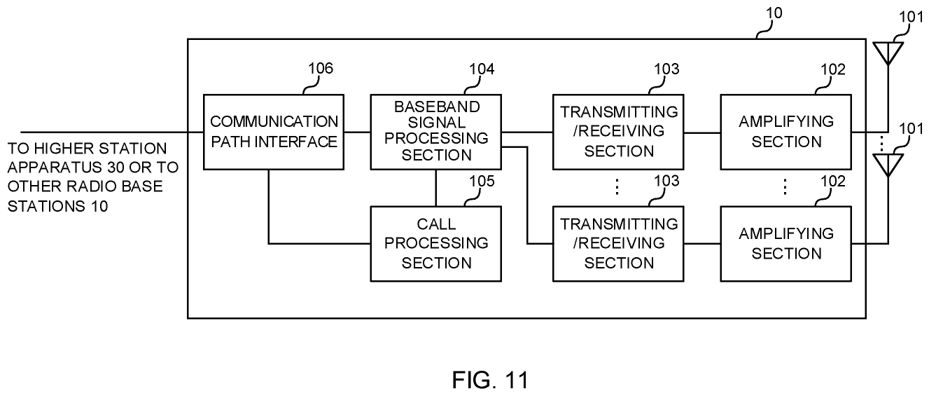

FIG. 11 is a diagram illustrating one example of an overall configuration of the radio base station according to the present embodiment. The radio base station 10 includes pluralities of transmission/reception antennas 101, amplifying sections 102 and transmission/reception sections 103, a baseband signal processing section 104, a call processing section 105 and a channel interface 106. In this regard, the radio base station 10 may be configured to include one or more of each of the transmission/reception antennas 101, the amplifying sections 102 and the transmission/reception sections 103.

User data transmitted from the radio base station 10 to the user terminal 20 on downlink is input from the higher station apparatus 30 to the baseband signal processing section 104 via the channel interface 106.

The baseband signal processing section 104 performs processing of a Packet Data Convergence Protocol (PDCP) layer, segmentation and concatenation of the user data, transmission processing of a Radio Link Control (RLC) layer such as RLC retransmission control, Medium Access Control (MAC) retransmission control (e.g., Hybrid Automatic Repeat reQuest (HARM) processing), and transmission processing such as at least one of scheduling, transmission format selection, channel coding, rate matching, scrambling, Inverse Fast Fourier Transform (IFFT) processing, and precoding processing on the user data, and transfers the user data to each transmission/reception section 103. Furthermore, the baseband signal processing section 104 performs transmission processing such as channel coding and/or inverse fast Fourier transform on a downlink control signal, too, and transfers the downlink control signal to each transmission/reception section 103.

Each transmission/reception section 103 converts a baseband signal precoded and output per antenna from the baseband signal processing section 104 into a radio frequency range, and transmits a radio frequency signal. The radio frequency signal subjected to frequency conversion by each transmission/reception section 103 is amplified by each amplifying section 102, and is transmitted from each transmission/reception antenna 101.

The transmission/reception sections 103 can be composed of transmitters/receivers, transmission/reception circuits or transmission/reception apparatuses described based on a common knowledge in a technical field according to the present invention. In this regard, the transmission/reception sections 103 may be composed as an integrated transmission/reception section or may be composed of transmission sections and reception sections.

Meanwhile, each amplifying section 102 amplifies a radio frequency signal received by each transmission/reception antenna 101 as a UL signal. Each transmission/reception section 103 receives the UL signal amplified by each amplifying section 102. Each transmission/reception section 103 performs frequency conversion on the received signal into a baseband signal, and outputs the baseband signal to the baseband signal processing section 104.

The baseband signal processing section 104 performs Fast Fourier Transform (FFT) processing, Inverse Discrete Fourier Transform (IDFT) processing, error correcting decoding, MAC retransmission control reception processing, and reception processing of an RLC layer and a PDCP layer on UL data included in the input UL signal, and transfers the UL data to the higher station apparatus 30 via the channel interface 106. The call processing section 105 performs at least one of call processing such as configuration and release of a communication channel, state management of the radio base station 10, and radio resource management.

The channel interface 106 transmits and receives signals to and from the higher station apparatus 30 via a given interface. Furthermore, the channel interface 106 may transmit and receive (backhaul signaling) signals to and from the neighboring radio base station 10 via an inter-base station interface (e.g., optical fibers compliant with the Common Public Radio Interface (CPRI) or the X2 interface).

Each transmission/reception section 103 receives uplink data (CBs) and Uplink Control Information (UCI) multiplexed on an uplink shared channel. Each transmission/reception section 103 may notify a UE of information related to a maximum value of the number of resources (the number of times of UCI multiplexing) to be respectively punctured in each CB.

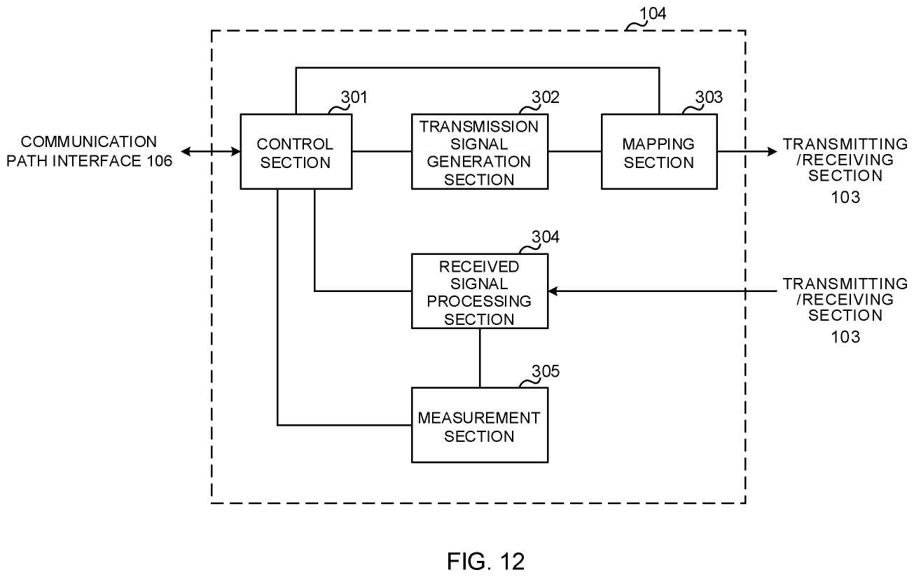

FIG. 12 is a diagram illustrating one example of a function configuration of the radio base station according to the present embodiment. In addition, FIG. 12 mainly illustrates function blocks of characteristic portions according to the present embodiment, and assumes that the radio base station 10 includes other function blocks, too, that are necessary for radio communication. As illustrated in FIG. 12, the baseband signal processing section 104 includes a control section 301, a transmission signal generating section 302, a mapping section 303, a received signal processing section 304 and a measurement section 305.

The control section 301 controls the entire radio base station 10. The control section 301 controls at least one of, for example, DL signal generation of the transmission signal generating section 302, DL signal mapping of the mapping section 303, UL signal reception processing (e.g., demodulation) of the received signal processing section 304, and measurement of the measurement section 305.

More specifically, the control section 301 schedules the user terminal 20. For example, the control section 301 controls a transmission timing and/or a transmission duration of the uplink shared channel, and a transmission timing and/or a transmission duration of the uplink control information. Furthermore, the control section 301 controls reception of the uplink shared channel on which the uplink data and the uplink control information are multiplexed.

The control section 301 can be composed of a controller, a control circuit or a control apparatus described based on the common knowledge in the technical field according to the present invention.

The transmission signal generating section 302 generates a DL signal (including a DL data signal, a DL control signal or a DL reference signal) based on an instruction from the control section 301, and outputs the DL signal to the mapping section 303.

The transmission signal generating section 302 can be composed of a signal generator, a signal generating circuit or a signal generating apparatus described based on the common knowledge in the technical field according to the present invention.

The mapping section 303 maps the DL signal generated by the transmission signal generating section 302, on given radio resources based on the instruction from the control section 301, and outputs the DL signal to each transmission/reception section 103. The mapping section 303 can be composed of a mapper, a mapping circuit or a mapping apparatus described based on the common knowledge in the technical field according to the present invention.

The received signal processing section 304 performs reception processing (e.g., demapping, demodulation and decoding) on a UL signal (including, for example, a UL data signal, a UL control signal and a UL reference signal) transmitted from the user terminal 20. More specifically, the received signal processing section 304 may output a received signal and/or a signal after the reception processing to the measurement section 305. Furthermore, the received signal processing section 304 performs UCI reception processing based on a UL control channel configuration instructed by the control section 301.

The measurement section 305 performs measurement related to the received signal. The measurement section 305 can be composed of a measurement instrument, a measurement circuit or a measurement apparatus described based on the common knowledge in the technical field according to the present invention.

The measurement section 305 may measure UL channel quality based on, for example, received power (e.g., Reference Signal Received Power (RSRP)) and/or received quality (e.g., Reference Signal Received Quality (RSRQ)) of a UL reference signal. The measurement section 305 may output a measurement result to the control section 301.

<User Terminal>

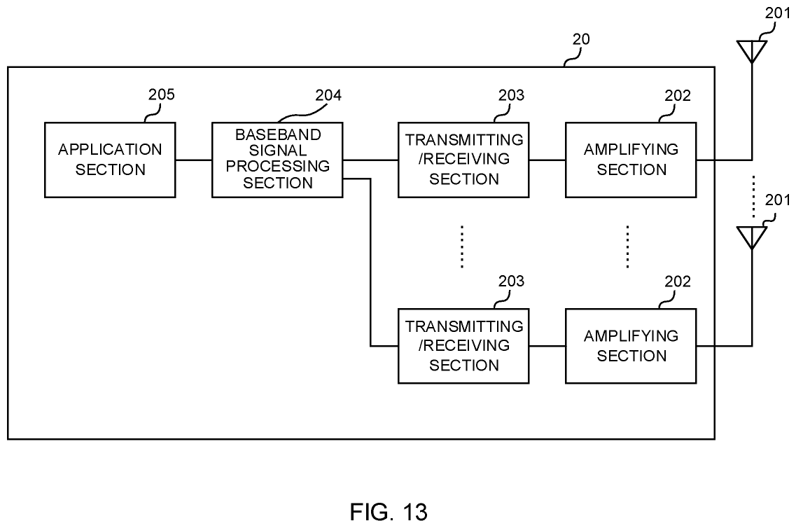

FIG. 13 is a diagram illustrating one example of an overall configuration of the user terminal according to the present embodiment. The user terminal 20 includes pluralities of transmission/reception antennas 201 for MIMO transmission, amplifying sections 202 and transmission/reception sections 203, a baseband signal processing section 204 and an application section 205.

The respective amplifying sections 202 amplify radio frequency signals received at a plurality of transmission/reception antennas 201. Each transmission/reception section 203 receives a DL signal amplified by each amplifying section 202. Each transmission/reception section 203 performs frequency conversion on the received signal into a baseband signal, and outputs the baseband signal to the baseband signal processing section 204.

The baseband signal processing section 204 performs at least one of FFT processing, error correcting decoding, and retransmission control reception processing on the input baseband signal. The baseband signal processing section 204 transfers DL data to the application section 205. The application section 205 performs processing related to layers higher than a physical layer and an MAC layer.

On the other hand, the application section 205 inputs UL data to the baseband signal processing section 204. The baseband signal processing section 204 performs at least one of retransmission control processing (e.g., HARQ processing), channel coding, rate matching, puncturing, Discrete Fourier Transform (DFT) processing and IFFT processing on the UL data, and transfers the UL data to each transmission/reception section 203. The baseband signal processing section 204 performs at least one of channel coding, rate matching, puncturing, DFT processing and IFFT processing on the UCI (e.g., at least one of A/N of the DL signal, Channel State information (CSI) and a Scheduling Request (SR)), and transfers the UCI to each transmission/reception section 203.

Each transmission/reception section 203 converts the baseband signal output from the baseband signal processing section 204 into a radio frequency range, and transmits a radio frequency signal. The radio frequency signal subjected to the frequency conversion by each transmission/reception section 203 is amplified by each amplifying section 202, and is transmitted from each transmission/reception antenna 201.

Furthermore, when the transmission duration of the uplink shared channel and at least part of the transmission duration of the uplink control information overlap, each transmission/reception section 203 transmits the uplink control information by using the uplink shared channel. Furthermore, when multiplexing the uplink data and the uplink control information on the uplink shared channel to transmit, each transmission/reception section 203 applies at least puncture processing and transmits the UCI. Each transmission/reception section 203 may receive information related to the maximum value of the number of resources (the number of times of UCI multiplexing) to be respectively punctured in each CB.

The transmission/reception sections 203 can be composed as transmitters/receivers, transmission/reception circuits or transmission/reception apparatuses described based on the common knowledge in the technical field according to the present invention. Furthermore, the transmission/reception sections 203 may be composed as an integrated transmission/reception section or may be composed of transmission sections and reception sections.

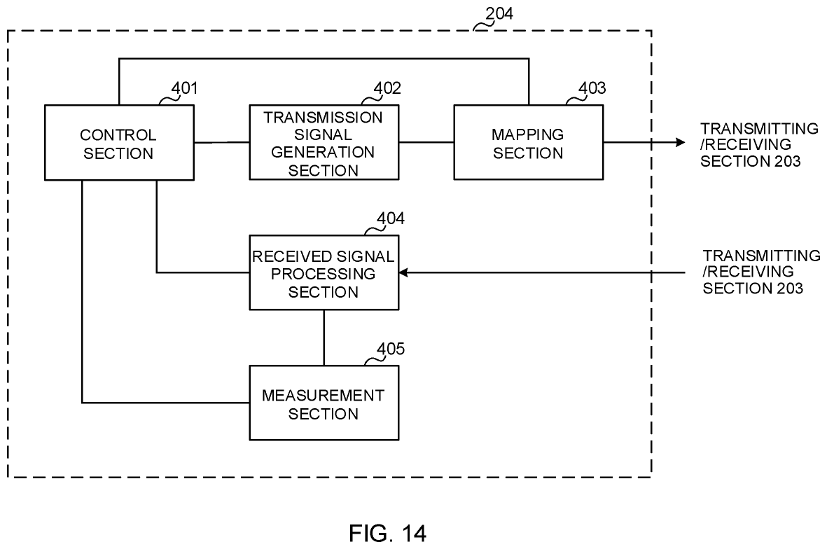

FIG. 14 is a diagram illustrating one example of a function configuration of the user terminal according to the present embodiment. In addition, FIG. 14 mainly illustrates function blocks of characteristic portions according to the present embodiment, and assumes that the user terminal 20 includes other function blocks, too, that are necessary for radio communication. As illustrated in FIG. 14, the baseband signal processing section 204 of the user terminal 20 includes a control section 401, a transmission signal generating section 402, a mapping section 403, a received signal processing section 404 and a measurement section 405.

The control section 401 controls the entire user terminal 20. The control section 401 controls at least one of, for example, UL signal generation of the transmission signal generating section 402, UL signal mapping of the mapping section 403, DL signal reception processing of the received signal processing section 404 and measurement of the measurement section 405.

Furthermore, the control section 401 controls transmission of the uplink data (e.g., CBs) and the Uplink Control Information (UCI) that uses the uplink shared channel (PUSCH). For example, the control section 401 transmits the uplink data per given block, and applies puncture processing, multiplexes the uplink control information and controls the transmission. In this case, the control section 401 controls multiplexing of the uplink control information such that the number of pieces of uplink control information (the number of resources to be punctured) to be multiplexed per given block of the uplink data is distributed and/or becomes a given value or less.

Furthermore, the control section 401 may perform control such that the number of resources to be punctured in each given block of the uplink data becomes identical (see FIGS. 5 and 6).

Furthermore, the control section 401 performs control to multiplex the uplink control information to be respectively multiplexed on each given block of the uplink data, on at least proximity positions (e.g., the closest positions) of Demodulation Reference Signals (DMRSs). For example, the control section 401 may apply interleaving to each CB of the uplink data and the uplink control information to be respectively inserted in each CB based on insertion positions of the uplink control information in each CB and DMRS positions (see FIGS. 7 and 8). Interleaving may be applied in a unit of 1 CB, a plurality of CBs or all CBs.

The control section 401 can be composed of a controller, a control circuit or a control apparatus described based on the common knowledge in the technical field according to the present invention.

The transmission signal generating section 402 generates (e.g., encodes, rate-matches, punctures and modulates) a UL signal (including a UL data signal, a UL control signal, a UL reference signal and UCI) based on an instruction from the control section 401, and outputs the UL signal to the mapping section 403. The transmission signal generating section 402 can be composed of a signal generator, a signal generating circuit or a signal generating apparatus described based on the common knowledge in the technical field according to the present invention.

The mapping section 403 maps the UL signal (e.g., the uplink data and the uplink control information) generated by the transmission signal generating section 402, on radio resources based on the instruction from the control section 401, and outputs the UL signal to each transmission/reception section 203. The mapping section 403 can be composed of a mapper, a mapping circuit or a mapping apparatus described based on the common knowledge in the technical field according to the present invention.

The received signal processing section 404 performs reception processing (e.g., demapping, demodulation and decoding) on the DL signal (a DL data signal, scheduling information, a DL control signal or a DL reference signal). The received signal processing section 404 outputs information received from the radio base station 10 to the control section 401. The received signal processing section 404 outputs, for example, broadcast information, system information, higher layer control information of a higher layer signaling such as an RRC signaling and physical layer control information (L1/L2 control information) to the control section 401.

The received signal processing section 404 can be composed of a signal processor, a signal processing circuit or a signal processing apparatus described based on the common knowledge in the technical field according to the present invention. Furthermore, the received signal processing section 404 can compose the reception section according to the present invention.

The measurement section 405 measures a channel state based on a reference signal (e.g., CSI-RS) from the radio base station 10, and outputs a measurement result to the control section 401. In addition, the measurement section 405 may measure the channel state per CC.

The measurement section 405 can be composed of a signal processor, a signal processing circuit or a signal processing apparatus, and a measurement instrument, a measurement circuit or a measurement apparatus described based on the common knowledge in the technical field according to the present invention.

<Hardware Configuration>

In addition, the block diagrams used to describe the above embodiment illustrate blocks in function units. These function blocks (components) are realized by an optional combination of hardware and/or software. Furthermore, a method for realizing each function block is not limited in particular. That is, each function block may be realized by using one physically and/or logically coupled apparatus or may be realized by using a plurality of these apparatuses formed by connecting two or more physically and/or logically separate apparatuses directly and/or indirectly (by using, for example, wired connection and/or radio connection).

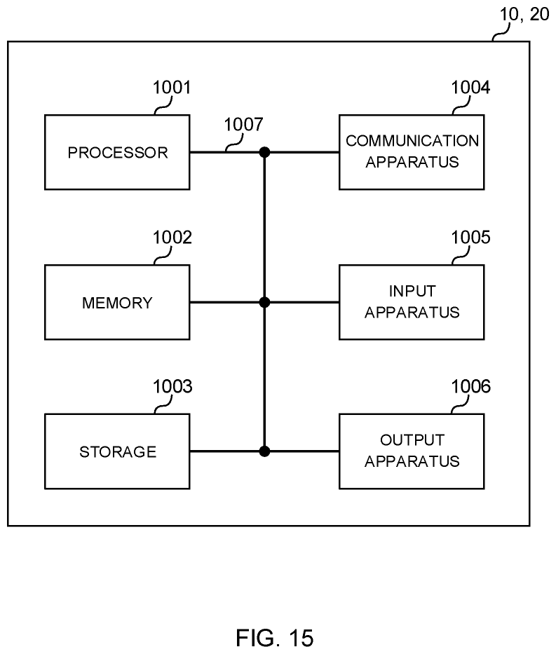

For example, the radio base station and the user terminal according to the present embodiment may function as computers that perform processing of the radio communication method according to the present invention. FIG. 15 is a diagram illustrating one example of the hardware configurations of the radio base station and the user terminal according to the present embodiment. The above-described radio base station 10 and user terminal 20 may be each physically configured as a computer apparatus that includes a processor 1001, a memory 1002, a storage 1003, a communication apparatus 1004, an input apparatus 1005, an output apparatus 1006 and a bus 1007.

In this regard, a word “apparatus” in the following description can be read as a circuit, a device or a unit. The hardware configurations of the radio base station 10 and the user terminal 20 may be configured to include one or a plurality of apparatuses illustrated in FIG. 15 or may be configured without including part of the apparatuses.

For example, FIG. 15 illustrates the only one processor 1001. However, there may be a plurality of processors. Furthermore, processing may be executed by 1 processor or processing may be executed by 1 or more processors concurrently, successively or by using another method. In addition, the processor 1001 may be implemented by 1 or more chips.

Each function of the radio base station 10 and the user terminal 20 is realized by, for example, causing hardware such as the processor 1001 and the memory 1002 to read given software (program), and thereby causing the processor 1001 to perform an operation, and control communication via the communication apparatus 1004 and reading and/or writing of data in the memory 1002 and the storage 1003.

The processor 1001 causes, for example, an operating system to operate to control the entire computer. The processor 1001 may be composed of a Central Processing Unit (CPU) including an interface for a peripheral apparatus, a control apparatus, an operation apparatus and a register. For example, the above-described baseband signal processing section 104 (204) and call processing section 105 may be realized by the processor 1001.

Furthermore, the processor 1001 reads programs (program codes), a software module or data from the storage 1003 and/or the communication apparatus 1004 out to the memory 1002, and executes various types of processing according to these programs, software module or data. As the programs, programs that cause the computer to execute at least part of the operations described in the above embodiment are used. For example, the control section 401 of the user terminal 20 may be realized by a control program that is stored in the memory 1002 and operates on the processor 1001, and other function blocks may be also realized likewise.

The memory 1002 is a computer-readable recording medium, and may be composed of at least one of, for example, a Read Only Memory (ROM), an Erasable Programmable ROM (EPROM), an Electrically EPROM (EEPROM), a Random Access Memory (RAM) and other appropriate storage media. The memory 1002 may be referred to as a register, a cache or a main memory (main storage apparatus). The memory 1002 can store programs (program codes) and a software module that can be executed to perform the radio communication method according to the present embodiment.

The storage 1003 is a computer-readable recording medium, and may be composed of at least one of, for example, a flexible disk, a floppy (registered trademark) disk, a magnetooptical disk (e.g., a compact disk (Compact Disc ROM (CD-ROM)), a digital versatile disk and a Blu-ray (registered trademark) disk), a removable disk, a hard disk drive, a smart card, a flash memory device (e.g., a card, a stick or a key drive), a magnetic stripe, a database, a server and other appropriate storage media. The storage 1003 may be referred to as an auxiliary storage apparatus.

The communication apparatus 1004 is hardware (transmission/reception device) that performs communication between computers via wired and/or radio networks, and will be also referred to as, for example, a network device, a network controller, a network card and a communication module. The communication apparatus 1004 may be configured to include a high frequency switch, a duplexer, a filter and a frequency synthesizer to realize, for example, Frequency Division Duplex (FDD) and/or Time Division Duplex (TDD). For example, the above-described transmission/reception antennas 101 (201), amplifying sections 102 (202), transmission/reception sections 103 (203) and channel interface 106 may be realized by the communication apparatus 1004.

The input apparatus 1005 is an input device (e.g., a keyboard, a mouse, a microphone, a switch, a button or a sensor) that accepts an input from an outside. The output apparatus 1006 is an output device (e.g., a display, a speaker or a Light Emitting Diode (LED) lamp) that sends an output to the outside. In addition, the input apparatus 1005 and the output apparatus 1006 may be an integrated component (e.g., touch panel).

Furthermore, each apparatus such as the processor 1001 or the memory 1002 is connected by the bus 1007 that communicates information. The bus 1007 may be composed by using a single bus or may be composed by using a bus that differs per apparatus.

Furthermore, the radio base station 10 and the user terminal 20 may be configured to include hardware such as a microprocessor, a Digital Signal Processor (DSP), an Application Specific Integrated Circuit (ASIC), a Programmable Logic Device (PLD) and a Field Programmable Gate Array (FPGA). The hardware may be used to realize part or all of each function block. For example, the processor 1001 may be implemented by using at least one of these types of hardware.

### Modified Example

In addition, each term that has been described in this description and/or each term that is necessary to understand this description may be replaced with terms having identical or similar meanings. For example, a channel and/or a symbol may be signals (signalings). Furthermore, a signal may be a message. A reference signal can be also abbreviated as an RS (Reference Signal), or may be also referred to as a pilot or a pilot signal depending on standards to be applied. Furthermore, a Component Carrier (CC) may be referred to as a cell, a frequency carrier and a carrier frequency.

Furthermore, a radio frame may include one or a plurality of durations (frames) in a time-domain. Each of one or a plurality of durations (frames) that composes a radio frame may be referred to as a subframe. Furthermore, the subframe may include one or a plurality of slots in the time-domain. The subframe may be a fixed time duration (e.g., 1 ms) that does not depend on the numerologies.

Furthermore, the slot may include one or a plurality of symbols (Orthogonal Frequency Division Multiplexing (OFDM) symbols or Single Carrier-Frequency Division Multiple Access (SC-FDMA) symbols) in the time-domain. Furthermore, the slot may be a time unit based on the numerologies. Furthermore, the slot may include a plurality of mini slots. Each mini slot may include one or a plurality of symbols in the time-domain. Furthermore, the mini slot may be referred to as a sub slot.

The radio frame, the subframe, the slot, the mini slot and the symbol each indicate a time unit for conveying signals. The other corresponding names may be used for the radio frame, the subframe, the slot, the mini slot and the symbol. For example, 1 subframe may be referred to as a Transmission Time Interval (TTI), a plurality of contiguous subframes may be referred to as TTIs, or 1 slot or 1 mini slot may be referred to as a TTI. That is, the subframe and/or the TTI may be a subframe (1 ms) according to legacy LTE, may be a duration (e.g., 1 to 13 symbols) shorter than 1 ms or may be a duration longer than 1 ms. In addition, a unit that indicates the TTI may be referred to as a slot or a mini slot instead of a subframe.

In this regard, the TTI refers to, for example, a minimum time unit of scheduling for radio communication. For example, in the LTE system, the radio base station performs scheduling for allocating radio resources (a frequency bandwidth or transmission power that can be used in each user terminal) in TTI units to each user terminal. In this regard, a definition of the TTI is not limited to this.

The TTI may be a transmission time unit of a channel-coded data packet (transport block), code block and/or codeword, or may be a processing unit of scheduling or link adaptation. In addition, when the TTI is given, a time period (e.g., the number of symbols) in which a transport block, a code block and/or a codeword are actually mapped may be shorter than the TTI.

In addition, when 1 slot or 1 mini slot is referred to as a TTI, 1 or more TTIs (i.e., 1 or more slots or 1 or more mini slots) may be a minimum time unit of scheduling. Furthermore, the number of slots (the number of mini slots) that compose a minimum time unit of the scheduling may be controlled.

The TTI having the time duration of 1 ms may be referred to as a general TTI (TTIs according to LTE Rel. 8 to 12), a normal TTI, a long TTI, a general subframe, a normal subframe or a long subframe. A TTI shorter than the general TTI may be referred to as a reduced TTI, a short TTI, a partial or fractional TTI, a reduced subframe, a short subframe, a mini slot or a subslot.

In addition, the long TTI (e.g., the general TTI or the subframe) may be read as a TTI having a time duration exceeding 1 ms, and the short TTI (e.g., the reduced TTI) may be read as a TTI having a TTI length less than the TTI length of the long TTI and equal to or more than 1 ms.

Resource Blocks (RBs) are resource allocation units of the time-domain and the frequency-domain, and may include one or a plurality of contiguous subcarriers in the frequency-domain. Furthermore, the RB may include one or a plurality of symbols in the time-domain or may have the length of 1 slot, 1 mini slot, 1 subframe or 1 TTI. 1 TTI or 1 subframe may each include one or a plurality of resource blocks. In this regard, one or a plurality of RBs may be referred to as a Physical Resource Block (PRB: Physical RB), a Sub-Carrier Group (SCG), a Resource Element Group (REG), a PRB pair or an RB pair.

Furthermore, the resource block may include one or a plurality of Resource Elements (REs). For example, 1 RE may be a radio resource domain of 1 subcarrier and 1 symbol.

In this regard, structures of the above-described radio frame, subframe, slot, mini slot and symbol are only exemplary structures. For example, configurations such as the number of subframes included in a radio frame, the number of slots per subframe or radio frame, the number of mini slots included in a slot, the numbers of symbols and RBs included in a slot or a mini slot, the number of subcarriers included in an RB, the number of symbols in a TTI, a symbol length and a Cyclic Prefix (CP) length can be variously changed.

Furthermore, the information and parameters described in this description may be expressed by using absolute values, may be expressed by using relative values with respect to given values or may be expressed by using other corresponding information. For example, a radio resource may be instructed by a given index.

Names used for parameters in this description are in no respect restrictive names. For example, various channels (the Physical Uplink Control Channel (PUCCH) and the Physical Downlink Control Channel (PDCCH)) and information elements can be identified based on various suitable names. Therefore, various names assigned to these various channels and information elements are in no respect restrictive names.

The information and the signals described in this description may be expressed by using one of various different techniques. For example, the data, the instructions, the commands, the information, the signals, the bits, the symbols and the chips mentioned in the above entire description may be expressed as voltages, currents, electromagnetic waves, magnetic fields or magnetic particles, optical fields or photons, or optional combinations of these.

Furthermore, the information and the signals can be output from a higher layer to a lower layer and/or from the lower layer to the higher layer. The information and the signals may be input and output via a plurality of network nodes.

The input and output information and signals may be stored in a specific location (e.g., memory) or may be managed by using a management table. The information and signals to be input and output can be overwritten, updated or additionally written. The output information and signals may be deleted. The input information and signals may be transmitted to other apparatuses.

Notification of information is not limited to the aspects/embodiment described in this description and may be performed by using other methods. For example, the information may be notified by a physical layer signaling (e.g., Downlink Control Information (DCI) and Uplink Control Information (UCI)), a higher layer signaling (e.g., a Radio Resource Control (RRC) signaling, broadcast information (Master Information Blocks (MIBs) and System Information Blocks (SIBs)), and a Medium Access Control (MAC) signaling), other signals or combinations of these.

In addition, the physical layer signaling may be referred to as Layer 1/Layer 2 (L1/L2) control information (L1/L2 control signal) or L1 control information (L1 control signal). Furthermore, the RRC signaling may be referred to as an RRC message, and may be, for example, an RRCConnectionSetup message or an RRCConnectionReconfiguration message. Furthermore, the MAC signaling may be notified by using, for example, an MAC Control Element (MAC CE).

Furthermore, notification of given information (e.g., notification of “being X”) is not limited to explicit notification, and may be performed implicitly (by, for example, not notifying this given information or by notifying another information).

Decision may be made based on a value (0 or 1) expressed as 1 bit, may be made based on a boolean expressed as true or false or may be made by comparing numerical values (by, for example, making comparison with a given value).

Irrespectively of whether software is referred to as software, firmware, middleware, a microcode or a hardware description language or as other names, the software should be widely interpreted to mean a command, a command set, a code, a code segment, a program code, a program, a subprogram, a software module, an application, a software application, a software package, a routine, a subroutine, an object, an executable file, an execution thread, a procedure or a function.

Furthermore, software, commands and information may be transmitted and received via transmission media. When, for example, the software is transmitted from websites, servers or other remote sources by using wired techniques (e.g., coaxial cables, optical fiber cables, twisted pairs and Digital Subscriber Lines (DSLs)) and/or radio techniques (e.g., infrared rays and microwaves), these wired techniques and/or radio techniques are included in a definition of the transmission media.

The terms “system” and “network” used in this description are compatibly used.

In this description, the terms “Base Station (BS)”, “radio base station”, “eNB”, “gNB”, “cell”, “sector”, “cell group”, “carrier” and “component carrier” can be compatibly used. The base station will be also referred to as a term such as a fixed station, a NodeB, an eNodeB (eNB), an access point, a transmission point, a reception point, a femtocell or a small cell in some cases.

The base station can accommodate one or a plurality of (e.g., three) cells (also referred to as sectors). When the base station accommodates a plurality of cells, an entire coverage area of the base station can be partitioned into a plurality of smaller areas. Each smaller area can also provide communication service via a base station subsystem (e.g., indoor small base station (RRH: Remote Radio Head)). The term “cell” or “sector” indicates part or the entirety of the coverage area of the base station and/or the base station subsystem that provide communication service in this coverage.

In this description, the terms “Mobile Station (MS)”, “user terminal”, “User Equipment (UE)” and “terminal” can be compatibly used. The base station will be also referred to as a term such as a fixed station, a NodeB, an eNodeB (eNB), an access point, a transmission point, a reception point, a femtocell or a small cell in some cases.

The mobile station will be also referred to by a person skilled in the art as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client or some other appropriate terms in some cases.

Furthermore, the radio base station in this description may be read as the user terminal. For example, each aspect/embodiment of the present invention may be applied to a configuration where communication between the radio base station and the user terminal is replaced with communication between a plurality of user terminals (D2D: Device-to-Device). In this case, the user terminal 20 may be configured to include the functions of the above-described radio base station 10. Furthermore, words such as “uplink” and “downlink” may be read as a “side”. For example, the uplink channel may be read as a side channel.

Similarly, the user terminal in this description may be read as the radio base station. In this case, the radio base station 10 may be configured to include the functions of the above-described user terminal 20.

In this description, operations performed by the base station are performed by an upper node of this base station depending on cases. Obviously, in a network including one or a plurality of network nodes including the base stations, various operations performed to communicate with a terminal can be performed by base stations, one or more network nodes (that are supposed to be, for example, Mobility Management Entities (MMES) or Serving-Gateways (S-GWs) yet are not limited to these) other than the base stations or a combination of these.

Each aspect/embodiment described in this description may be used alone, may be used in combination or may be switched and used when carried out. Furthermore, orders of the processing procedures, the sequences and the flowchart according to each aspect/embodiment described in this description may be rearranged unless contradictions arise. For example, the method described in this description presents various step elements in an exemplary order and is not limited to the presented specific order.

Each aspect/embodiment described in this description may be applied to Long Term Evolution (LTE), LTE-Advanced (LTE-A), LTE-Beyond (LTE-B), SUPER 3G IMT-Advanced, the 4th generation mobile communication system (4G), the 5th generation mobile communication system (5G), Future Radio Access (FRA), the New Radio Access Technology (New-RAT), New Radio (NR), New radio access (NX), Future generation radio access (FX), Global System for Mobile communications (GSM) (registered trademark), CDMA2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other appropriate radio communication methods and/or next-generation systems that are expanded based on these systems.

The phrase “based on” used in this description does not mean “based only on” unless specified otherwise. In other words, the phrase “based on” means both of “based only on” and “based at least on”

Every reference to elements that use names such as “first” and “second” used in this description does not generally limit the quantity or the order of these elements. These names can be used in this description as a convenient method for distinguishing between two or more elements. Hence, the reference to the first and second elements does not mean that only two elements can be employed or the first element should precede the second element in some way.

The term “deciding (determining)” used in this description includes diverse operations in some cases. For example, “deciding (determining)” may be regarded to “decide (determine)” calculating, computing, processing, deriving, investigating, looking up (e.g., looking up in a table, a database or another data structure) and ascertaining. Furthermore, “deciding (determining)” may be regarded to “decide (determine)” receiving (e.g., receiving information), transmitting (e.g., transmitting information), input, output and accessing (e.g., accessing data in a memory). Furthermore, “deciding (determining)” may be regarded to “decide (determine)” resolving, selecting, choosing, establishing and comparing. That is, “deciding (determining)” may be regarded to “decide (determine)” some operation.

The words “connected” and “coupled” used in this description or every modification of these words can mean every direct or indirect connection or coupling between 2 or more elements, and can include that 1 or more intermediate elements exist between the two elements “connected” or “coupled” with each other. The elements may be coupled or connected physically, logically or by a combination of the physical and logical connections. For example, “connection” may be read as “access”.

It can be understood that, when connected in this description, the two elements are “connected” or “coupled” with each other by using 1 or more electric wires, cables and/or printed electrical connection, and by using electromagnetic energy having wavelengths in radio frequency domains, microwave domains and/or (both of visible and invisible) light domains in some non-restrictive and non-comprehensive examples.

A sentence that “A and B are different” in this description may mean that “A and B are different from each other”. Words such as “separate” and “coupled” may be also interpreted in a similar manner.

When the words “including” and “comprising” and modifications of these words are used in this description or the claims, these words intend to be comprehensive similar to the word “having”. Furthermore, the word “or” used in this description or the claims intends not to be an XOR.

The present invention has been described in detail above. However, it is obvious for a person skilled in the art that the present invention is not limited to the embodiment described in this description. The present invention can be carried out as modified and changed aspects without departing from the gist and the scope of the present invention defined based on the recitation of the claims. Accordingly, the disclosure of this description is intended for exemplary explanation, and does not bring any restrictive meaning to the present invention.

1. A user terminal comprising:
a transmission section that transmits uplink data and uplink control information by using an uplink shared channel; and
a control section that controls multiplexing of the uplink control information such that a number of pieces of the uplink control information to be multiplexed per given block of the uplink data is distributed and/or becomes a given value or less.

2. The user terminal according to claim 1, wherein the control section performs control such that a number of resources to be punctured in each given block of the uplink data becomes identical.

3. The user terminal according to claim 1, wherein the control section performs control to multiplex the uplink control information on a position, the uplink control information being each multiplexed on each given block of the uplink data, and the position being the closest to a demodulation reference signal.

4. The user terminal according to claim 3, wherein the control section applies interleaving to each given block of the uplink data and the uplink control information to be inserted in each given block.

5. A radio communication method of a user terminal comprising:
transmitting uplink data and uplink control information by using an uplink shared channel; and
controlling multiplexing of the uplink control information such that a number of pieces of the uplink control information to be multiplexed per given block of the uplink data is distributed and/or becomes a given value or less.

6. The user terminal according to claim 2, wherein the control section performs control to multiplex the uplink control information on a position, the uplink control information being each multiplexed on each given block of the uplink data, and the position being the closest to a demodulation reference signal.
